(19) United States
(12) Patent Application Publication
(10) Pub. No.: US 2024/0320573 A1
(43) Pub. Date: Sep. 26, 2024

(54) Aircraft Fleet Assignment With Slot Constraints

(71) Applicant: The Boeing Company, Arlington, VA (US)

(72) Inventors: Åke Mattias Grönkvist, Sãvedalen (SE); Carl Johan Willard Kellerth Fredlund, Gothenburg (SE); Jens Ivan Arne Kjerrström, Gothenburg (SE); Lars Tomas Larsson, Gothenburg (SE); Chi Thong Luong, Gothenburg (SE); Karl Erik Andreas Westerlund, Gothenburg (SE)

(21) Appl. No.: 18/186,873

(22) Filed: Mar. 20, 2023

(51) Int. Cl. G06Q 10/0631

(52) U.S. Cl. CPC G06Q 10/06311

(57) ABSTRACT

A method, apparatus, system, and computer program product for managing slots. The slots allocated to an airline are identified by computer system. A model that describes a relationship of flights in an input flight schedule and the slots that have been allocated subject to constraints is created by the computer system. An output flight schedule is created by the computer system using the model to obtain an extrema using a set of objectives. The flights are aligned to the slots in the output flight schedule.

### BACKGROUND INFORMATION

### 1. Field

The present disclosure relates generally to computer system and in particular, to a method, apparatus, system, and computer program product for managing fleet assignment of slots at airports.

### 2. Background

A slot is an authorization to take off or land at a particular airport on a particular day at a specified time. A slot can be a landing slot, a takeoff slot, or a turn-slot combining a landing slot and a takeoff slot. Slots are allocated twice a year following a series of events, where the slot conference that allows airlines and coordinators to meet and work to obtain slots for use in flight schedules, is the most important.

When an airline receives the initial slots for the coming season, a schedule for that season has already been established. Further, tickets are out for sale for the season. The assigned slots may not align with the schedule that has been established. The airline may change the schedule to match the flights with the slots. Additionally, the airline can request to change slots. An airline can work with a slot coordinator to move slots at an airport. A slot coordinator can be in charge of slots for a single airport or a region. Currently, revising schedules to align the flights and slots can be a time-consuming process.

Therefore, it would be desirable to have a method and apparatus that take into account at least some of the issues discussed above, as well as other possible issues. For example, it would be desirable to have a method and apparatus that overcome a problem with aligning flights in schedules with assigned slots and negotiating slight changes.

### SUMMARY

An embodiment of the present disclosure provides a method for managing slots. The slots allocated to an airline are identified by computer system. A model that describes a relationship of flights in an input flight schedule and the slots that have been allocated subject to constraints is created by the computer system. An output flight schedule is created by the computer system using the model to obtain an extrema using a set of objectives. The flights are aligned to the slots in the output flight schedule.

In yet another embodiment of the present disclosure, a flight scheduling system comprises a computer system and a schedule generator in the computer system. The schedule generator is configured to identify slots allocated to an airline. The scheduler is configured to create a model that describes a relationship between flights for an input flight schedule and the slots that have been allocated subject to constraints. The schedule generator is configured to generate an output flight schedule using the model to obtain an extrema using a set of objectives, wherein the flights are aligned to the slots in the output flight schedule.

In still another illustrative embodiment of the present disclosure, a computer program product manages slots. The computer program product comprising a computer readable storage medium having program instructions embodied therewith, the program instructions executable by a computer system to cause the computer system to identify the slots allocated to an airline; create a model that describes a relationship between flights for an input flight schedule and the slots that have been allocated subject to constraints; and generate an output flight schedule using the model to obtain an extrema using a set of objectives, wherein the flights are aligned to the slots in the output flight schedule.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 is a block diagram of a flight environment in accordance with an illustrative embodiment;

FIG. 3 is an illustration of a data flow diagram for managing slots in a schedule in accordance with an illustrative embodiment;

FIG. 4 is an illustration of potential flight allocation changes to slots in accordance with an illustrative embodiment;

FIG. 5 is an illustration of a flowchart of a process for managing slots in accordance with an illustrative embodiment;

FIG. 6 is an illustration of a flowchart of a process for iteratively generating and output schedule in accordance with an illustrative embodiment;

FIG. 7 is an illustration of a flowchart of a process for iteratively generating and output schedule in accordance with an illustrative embodiment;

FIG. 8 is an illustration of a flowchart of process for swapping slots in accordance with an illustrative embodiment;

FIG. 9 is an illustration of a flowchart of a process for sending output schedules in accordance with an illustrative embodiment; and

FIG. 10 is an illustration of a block diagram of a data processing system in accordance with an illustrative embodiment.

### DETAILED DESCRIPTION

The illustrative embodiments recognize and take into account one or more different considerations. aligning schedules with slots and requesting slot movement or changes is a difficult process. A conflict is present in keeping the intent of the schedule against aligning the schedule with available slots. Further, requesting slot changes can be made but only to a certain extent. The ability to obtain slight changes may depend on other airlines wish to move slots for having available slots.

Thus, the illustrative examples provide a method, apparatus, system, for managing slots for an aircraft fleet. In one illustrative example, the scheduler can focus on the quality of the schedule while aligning the schedule to available slots. In the illustrative example, the schedule generator can enable identifying schedule changes and potential slot movement based on analyzing a schedule with allocated slots in a manner that increases the ability to at least one of reduce schedule changes or reduce slot changes.

Thus, illustrative examples provide a method, apparatus, system, and computer program product for managing slots. In these illustrative examples, the slots are slots allocated to an airline. A model that describes a relationship of flights in an input flight schedule and slots that have been allocated subject to constraints is created by the computer system. An output flight schedule is created by the computer system using the model to obtain an extrema using a set of objectives, wherein the flights are aligned to the slots in the output flight schedule.

As used herein, a “set of” when used with reference items means one or more items. For example, a set of objectives is one or more objectives.

In the illustrative example, the process aligning slots to schedules can be performed using objectives. These objectives can take the form of key performance indicators. These key performance indicators can include, for example, revenue, operating costs, and turn-time buffers.

The illustrative embodiments recognize and take into account one or more different considerations.

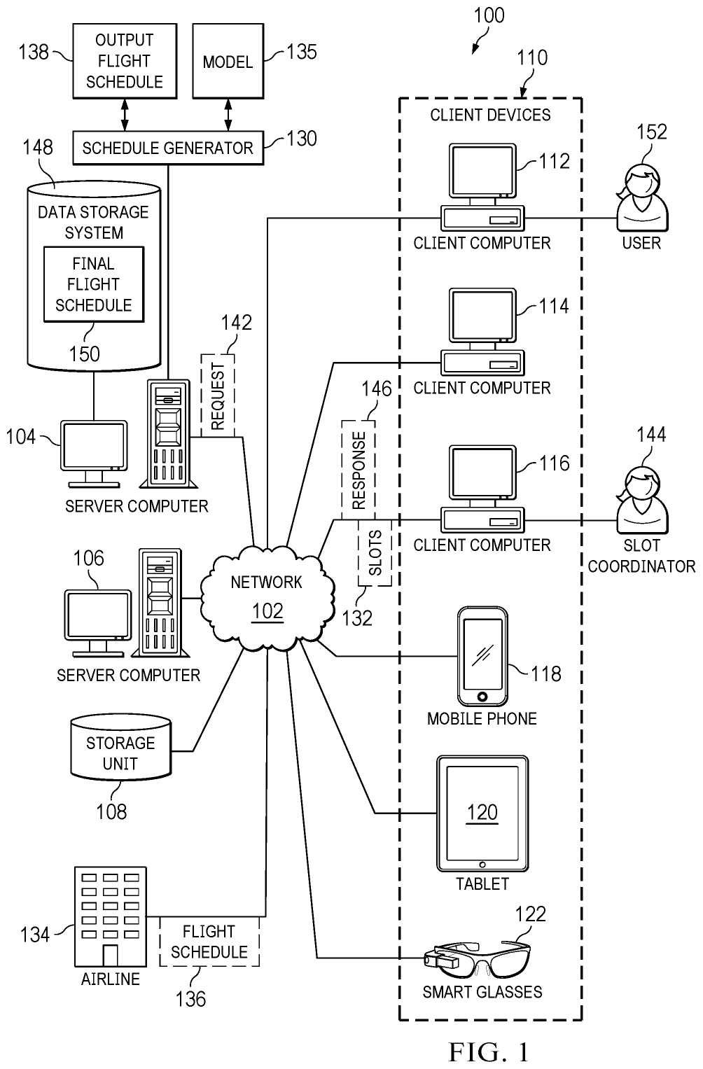

With reference now to the figures and, in particular, with reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client devices 110 connect to network 102. As depicted, client devices 110 include client computer 112, client computer 114, and client computer 116. Client computers can be computers used by a schedule generator to manipulate the schedule, agents inside or outside the airline that access flight schedule information, and slot coordinator 144 (outside the airline) that receive slot requests and send back feedback.

In the depicted example, server computer 104 provides information, such as boot files, operating system images, and applications to client devices 110. Further, client devices 110 can also include other types of client devices such as mobile phone 118, tablet computer 120, and smart glasses 122. In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program instructions located in network data processing system 100 can be stored on a computer-recordable storage medium and downloaded to a data processing system or other device for use. For example, program instructions can be stored on a computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols or standard web services protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

As used herein, “a number of” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items can be used from the list, but not all of the items in the list are required. The item can be a particular object, thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B and ten of item C; four of item B and seven of item C; or other suitable combinations. The item can be a particular object, a thing, or a category.

In this illustrative example, schedule generator 130 can manage slots 132 allocated to airline 134. In this example, slots 132 are slots for an aircraft fleet operated by airline 134. In this example, airline 134 can send slots 132 and flight schedule 136 to schedule generator 130 over network 102.

Schedule generator 130 can create model 135 that describes the relationship of flights in the flight schedule 136 and slots 132 to airline 134. Model 135 can also include constraints. These constraints can be, for example, available aircraft in the fleet, buffer time between flights, the size of aircraft, or other constraints.

In this illustrative example, schedule generator 130 can generate output flight schedule 138 using model 135 to obtain a maximization or a minimization of a set of objectives. In this example, flights in output flight schedule 138 can be aligned with slots 132 in this flight schedule.

Depending on the acceptability of output flight schedule 138, changes to at least one of the schedule or constraints such as schedule requirements can be made. These changes can be used to regenerate output flight schedule 138 using model 135.

Further, depending on the acceptability of output flight schedule 138, schedule generator 130 can send request 142 to slot coordinator 144 at client computer 116 to change one or more of the slots 132 flight in output flight schedule 138. Slot coordinator 144 can return response 146 indicating whether if any or all of flight changes in request 142 have been accepted. In response to changes being made to slots 132, output flight schedule 138 can be regenerated using slots 132 with the changes and flight schedule 136.

When output flight schedule 138 is considered usable, output flight schedule 138 can be stored in data storage system 148 as final flight schedule 150. Final flight schedule 150 can be retrieved and sent over network 102 in response to different events. For example, user 152 can request information about flights in final flight schedule 150 in one illustrative example. This request is an example of an event relating to that information regarding flights in final flight schedule 150 is transferred to client computer 112 over network 102.

In this example, user 152 can be, for example, a crew scheduler that creates flight crew rosters. These rosters can be planned based on information about flights in final flight schedule 150.

In another illustrative example, user 152 can be a passenger reservation system receiving information about updated flights I the flight schedule. In yet another illustrative example, user 152 can be a maintenance planner obtaining information about flights.

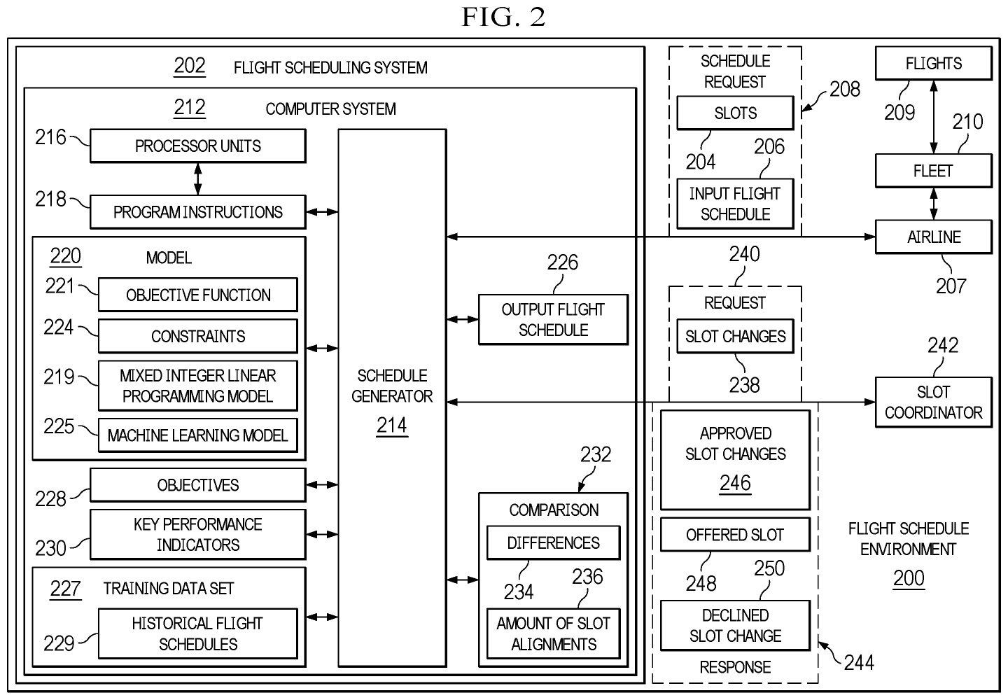

With reference now to FIG. 2, a block diagram of a flight environment is depicted in accordance with an illustrative embodiment. In this illustrative example, flight schedule environment 200 includes components that can be implemented in hardware such as the hardware shown in network data processing system 100 in FIG. 1.

In this illustrative example, flight scheduling system 202 in flight schedule environment 200 can operate to manage slots 204 with respect to input flight schedule 206 for airline 207. As depicted, flight scheduling system 202 comprises computer system 212 and schedule generator 214. Schedule generator 214 is located in computer system 212.

Schedule generator 214 can be implemented in software, hardware, firmware or a combination thereof. When software is used, the operations performed by schedule generator 214 can be implemented in program instructions configured to run on hardware, such as a processor unit. When firmware is used, the operations performed by schedule generator 214 can be implemented in program instructions and data and stored in persistent memory to run on a processor unit. When hardware is employed, the hardware may include circuits that operate to perform the operations in schedule generator 214.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 212 is a physical hardware system and includes one or more data processing systems. When more than one data processing system is present in computer system 212, those data processing systems are in communication with each other using a communications medium. The communications medium may be a network. The data processing systems may be selected from at least one of a computer, a server computer, a tablet, or some other suitable data processing system.

As depicted, computer system 212 includes a number of processor units 216 that are capable of executing program instructions 218 implementing processes in the illustrative examples. In other words, program instructions 218 are computer readable program instructions.

As used herein, a processor unit in the number of processor units 216 is a hardware device and is comprised of hardware circuits such as those on an integrated circuit that respond to and process instructions and program code that operate a computer. When the number of processor units 216 executes program instructions 218 for a process, the number of processor units 216 can be one or more processor units that are on the same computer or on different computers. In other words, the process can be distributed between processor units 216 on the same or different computers in computer system 212.

Further, the number of processor units 216 can be of the same type or different type of processor units. For example, a number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In this example, airline 207 can send an identification of slots 204 and can send input flight schedule 206 in schedule request 208 to schedule generator 214. In this example, input flight schedule 206 is a flight schedule for fleet 210 operated by airline 207.

As depicted, schedule generator 214 can identify slots 204 allocated to airline 207. In this example, slots 204 can be identified from schedule request 208. Schedule generator 214 creates model 220 that describes a relationship between flights 209 in input flight schedule 206 and slots 204 that have been allocated subject to constraints 224. In one illustrative example, model 220 can comprise objective function 221 and constraints 224 and can be mixed integer linear programming model 219. In this example, schedule generator 214 can include optimization process that uses model 220 to obtain output flight schedule 226.

Schedule generator 214 can generate output flight schedule 226 using model 220 to obtain an extrema using a set of objectives 228. The extrema can be a minimization or maximization using the set of objectives 228.

For example, schedule generator 214 can maximize a parameter such as the number of flights 209 that match slots 204. In other words, increasing the matching of flights 209 to slots 204, increase alignment between flights 209 and slots 204 can occur. To increase the matching, flight times can be adjusted by schedule generator 214 subject to constraints 224. Adjusting the flight times to increase matches between flights 209 and slots 204 can be performed by schedule generator 214.

In this example, flights 209 are aligned to slots 204 in output flight schedule 226. In this example, the output can be generated by schedule generator 214 using an optimization process such as a generated using a branch and bound optimization process.

In generating output flight schedule 226, schedule generator 214 can swap slots 204 between flights 209 such that increased alignment of slots 204 with flights 209 occurs. The increased alignment can mean that slots swapped between two flights result in both flights being aligned with the slots. In other words, both the departure time for both flights can have the same time as slots. In this example, swapping of slots is based on an airport. In other words, slots 204 can be swapped between flights 209 taking off or landing at the same airport.

In this illustrative example, key performance indicators 230 are used to create objectives 228. In this illustrative example, key performance indicator is a metric of a specific objective. For example, key performance indicator can be weighted slot deviation. The objective of this key performance indicator can be to minimize the deviation in time between flights and their slots using different weights to model the expected difficulty in modifying slots at different airports at different times. Another key performance indicator can be utilization by fleet 210. Another key performance indicator can be to create sufficient room for maintenance. The objective for this key performance indicator can be to reduce maintenance cost.

Further, in one illustrative example, schedule generator 214 can adjust a number of flights 209 in output flight schedule 226. Output flight schedule 226 with adjustments to the number of flights 209 becomes the input flight schedule 206 to perform another iteration in response to output flight schedule 226 being unacceptable for use. The determination of whether output flight schedule 226 can be performed by determining how closely output flight schedule 226 is to input flight schedule 206. This example, the determination can be made by comparing the scheduling of flights 209 in output flight schedule 226 to the scheduling of flights 209 input flight schedule 206.

Further, the determination of whether output flight schedule 226 is acceptable for use can also be made by determining on the number of slots 204 aligned with flights 209, the amount of slot misalignment, the amount flight changes between output flight schedule 226 and input flight schedule 206, and other factors that can be used to measure the acceptability of input flight schedule 206 for use in operating fleet 210 to provide service.

These determinations form comparison 232. Comparison 232 identifies differences 234 between output flight schedule 226 and input flight schedule 206. This comparison can also include number of alignments 236 between slots 204 and flights 209 in output flight schedule 226. These and other measurements, such as expected revenue, can be used to determine whether output flight schedule 226 is acceptable for use. In one illustrative example, comparison 232 can be compared to a threshold for differences 234 and number of alignments 236 between slots 204 and flights 209 in determining whether output flight schedule 226 is acceptable. The threshold can indicate the maximum number of differences 234 between flights 209 in output flight schedule 226 and input flight schedule 206. The threshold can also define a minimum number of alignments 236 between slots 204 and flights 209 that are required.

In this illustrative example, an alignment is present between a slot and a flight when the slot in the flight had the same time.

In this illustrative example, schedule generator 214 can repeat creating model 220, generating output flight schedule 226, adjusting output flight schedule 226 until the output flight schedule 226 is acceptable for use.

Additionally, schedule generator 214 can adjust the set of objectives 228 in response to output flight schedule 226 being unacceptable for use. Schedule generator 214 can then repeat creating model 220, generating output flight schedule 226, adjusting output flight schedule 226 until the output flight schedule 226 is acceptable for use. For example, an objective to reduce operating costs to a selected level can be changed to a different level depending on how close output flight schedule 226 is to input flight schedule 206.

In this illustrative example, output flight schedule 226 can be considered acceptable for use even when some of slots 204 may not be aligned as desired with flights 209. For example, a slot may be for a departure at time t1 while the flight is scheduled for time t1 plus 10 minutes.

In one illustrative example, schedule generator 214 can identify a set of slot changes 238 in response to output flight schedule 226 being acceptable for use. These slot changes can be identified based on which slots are not aligned with flights 209 with output flight schedule 226. Slots can be selected based on the amount of misalignment of a flight with a slot. For example, a threshold of 10 minutes may be selected for selecting slots 204. For example, if the difference between the flight and the slot is 5 minutes, that flight can be selected for inclusion in slot changes 238. The requests can be to obtain a slot that aligns with the flight. For example, the request can be made to exchange the slot at time t for a slot at time t plus 5 minutes. In this example, selecting slots with lower differences with the flights assigned to those slots can increase the likelihood an approval of a slot change will occur.

Schedule generator 214 sends request 240 to change the set of slots 204 to slot coordinator 242. Slot coordinator 242 is an authority that can authorize changes for slots 204. Slot coordinator 242 can be different for different airports, regions, or countries.

Slot coordinator 242 returns response 244. Response 244 can include approved slot changes 246. In this example, approved slot change 246 identifies slots moved in time, swapped slots, or change of aircraft type. In this example, offered slot 248 identifies an offer from the slot coordinator 242 of a change to an existing slot or a new slot. Declined slot change 250 identifies a response from the slot coordinator 242 where the requested slot change has been declined. Schedule generator 214 can repeat creating model 220 generating output flight schedule 226 using response 244 as a result of a change to slots 204 made in response to request 240 to change the set of slots 204 sent to slot coordinator 242.

In one illustrative example, one or more technical solutions are present that overcome a technical problem for the airline 207 how best make use of available slots. As a result, one or more technical solutions may provide a technical effect generating improved flight schedules based on matching flights to slots. In the illustrative examples, slots are not tightly linked to flights. As a result, the flights can be interchanged or swapped as needed between different slots to obtain matches between flights and slots and to reduce the amount of mismatch between flights and slots when exact matches are not possible. The matching of slots is subject to constraints such as using slots for flights in the same airport. Further, constraints in swapping slots can also be based on slots being swapped for same type of aircraft or aircraft of a similar weight and performance.

Computer system 212 can be configured to perform at least one of the steps, operations, or actions described in the different illustrative examples using software, hardware, firmware or a combination thereof. As a result, computer system 212 operates as a special purpose computer system in which schedule generator 214 in computer system 212 enables matching slots with flight and changing flights to provide matches between flights and slots subject to constraints. In particular, schedule generator 214 transforms computer system 212 into a special purpose computer system as compared to currently available general computer systems that do not have schedule generator 214.

The illustration of flight schedule environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, model 220 can be implemented using machine learning model 225 instead of mixed integer linear programming model 219. A machine learning model is a type of artificial intelligence model that can learn without being explicitly programmed. A machine learning model can learn based on training data input into the machine learning model.

The machine learning model can learn using various types of machine learning algorithms. The machine learning algorithms include at least one of a supervised learning, and unsupervised learning, a feature learning, a sparse dictionary learning, an anomaly detection, a reinforcement learning, a recommendation learning, or other types of learning algorithms.

Examples of machine learning models include an artificial neural network, a convolutional neural network, a decision tree, a support vector machine, a regression machine learning model, a classification machine learning model, a random forest learning model, a Bayesian network, a genetic algorithm, and other types of models. These machine learning models can be trained using data and process additional data to provide a desired output, such as output flight schedule 226.

In this example, when model 220 is implemented using machine learning model 225, machine learning model 225 can be trained using training data set 227. Training data set 227 can comprise historical flight schedules 229 that identify flights and slots used by those flights. With machine learning model 225, objective function 221 can be implemented in machine learning model 225 as a problem to be optimized. For example, a candidate solution, such as a flight schedule with slot alignments, can be input into machine learning model 225 and this solution can be evaluated against a portion of training data set 227. The cost can be an error score or loss in machine learning model 225.

In this example, when model 220 takes the form of machine learning model 225, schedule generator 214 can use machine learning model 225 to maximize a parameter by treating output of machine learning model 225 as the objective function to be maximized. A similar process can be used to minimize a particular parameter.

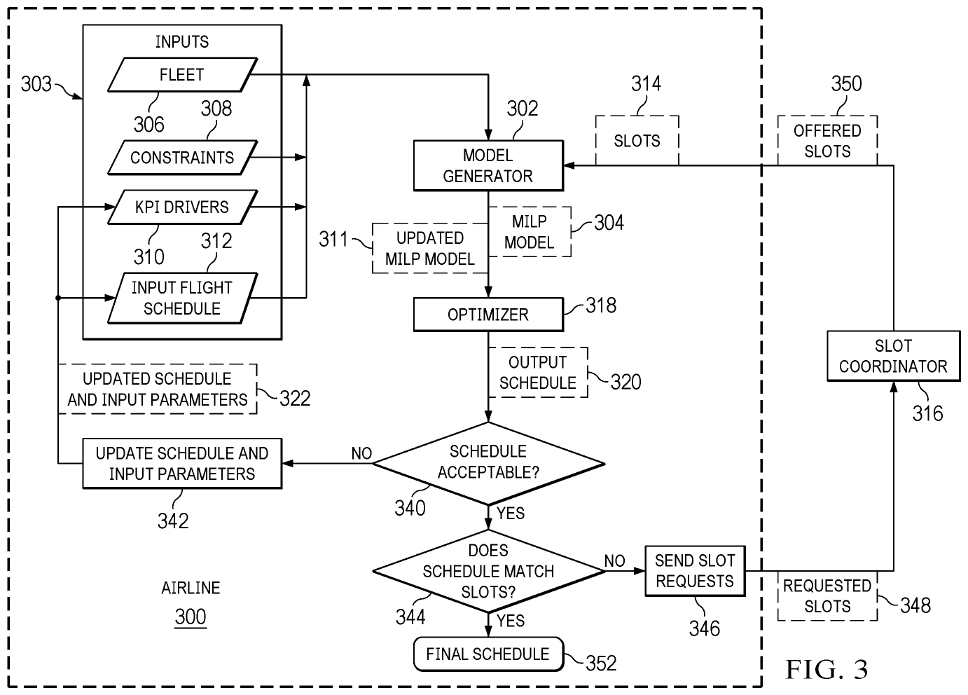

With reference next to FIG. 3, an illustration of a data flow diagram for managing slots in a schedule is depicted in accordance with an illustrative embodiment. Data flow illustrated in this figure can be implemented using flight scheduling system 202 in FIG. 2. This dataflow can be implemented using schedule generator 214 and other components in flight scheduling system 202 in FIG. 2. As depicted, the data flow in this figure is for airline 300. As depicted, the dataflow includes inputs to model generator 302 that model generator uses to create mixed integer linear programming model (MILP) model 304.

In this illustrative example, inputs 303 comprise a number of different types of information. As depicted, inputs 303 comprise fleet 306, constraints 308, key performance indicator (KPI) drivers 310, and input flight schedule 312.

In this illustrative example, fleet 306 are the aircraft available to operate a flight schedule. Constraints 308 are limits to using fleet 306 in the flight schedule. These limits can be, for example, limits to routes and airports that fleet 306 can operate.

Key performance indicator drivers 310 describes measurements used to evaluate objectives. These measurements can include, for example, revenue, costs, asset usage, maintenance, fuel consumption, and other measurements that can be used to evaluate the quality of a flight schedule. Tuning of these drivers may be performed to obtain a desired flight schedule.

Input flight schedule 312 is the preferred flight schedule for airline 300. Input flight schedule 312 can identify routes, airports, and dates for flights. In this example, input flight schedule 312 does not contain slots.

In this illustrative example, model generator 302 also receives slots 314 from slot coordinator 316. Slots 314 are slots for different airports assigned to flights for fleet 306. In this illustrative example, each slot prescribes a certain departure or arrival time as well as aircraft type for a flight to or from a particular airport. In this example, slots 314 are the initial set of slots that can be refined during an iterative process between slot coordinator 316 and airline 300 through this dataflow.

As depicted, model generator 302 receives inputs 303 and slots 314 to generate mixed integer linear programming model (MILP) model 304. Optimizer 318 uses mixed integer linear programming model (MILP) model 304 to generate output schedule 320. In generating output schedule 320, mixed integer linear programming model (MILP) model 304 can perform different operations including assigning flights to slots, changing flight times, and other operations.

In this illustrative example, output schedule 320 comprises a timing of flights, assignment of aircraft type to flight, and an assignment of flights to slots. In this illustrative example, the revised schedule together with assignments of flights to slots are present in output schedule 320.

With current techniques, a flight is coupled to a specific slot. In this example, optimizer 318 treats slots 314 as a portfolio of assets and allows flights to be scheduled to any nearby slot. With this type of optimization, a higher-quality schedule can be generated.

In this illustrative example, output schedule 320 can be analyzed to determine whether this output schedule is acceptable for use (block 340). The analysis can include determining the amount of alignment between flights and slots 314. Further, the analysis can also include determining whether flights have been changed in aligning flights with slots 314.

If output schedule 320 is not acceptable, the process updates the schedule and input parameters (block 342). In this illustrative example, the updated schedule becomes input flight schedule 312. The updated input parameters become key performance indicator (KPI) drivers 310 in this example. The same slots are used in this example. The process then generates updated mixed integer linear programming model (MILP) model 311 with inputs 303. This process can be performed iteratively until an acceptable output schedule is identified.

With reference again to block 340, if output schedule 320 is determined to be acceptable, a determination is made as to whether the schedule matches the slots (block 344). Output schedule 320 may be acceptable even if an alignment between all of the flights and slots are not present. In other words, a mismatch of some slots for flights may occur. If the schedule does not match the slots, the process can send slot requests (block 346).

In this example, requested slots 348 are sent to slot coordinator 316. Requested slots 348 can include a request to change at least one of a timing of slots or an assignment of aircraft types to slots. In response to receiving this response, slot coordinator 316 provides one or more of requested slots 348. As depicted, slot coordinator 316 can return offered slots 350 to model generator 302. Model generator uses offered slots 350 and inputs 303 to generate mixed integer linear programming model (MILP) model 304. In this example, offered slots 350 can be slots offered based off of requested slots 348. In this case, offered slots 350 can be used with slots 314 to generate model. In other cases, offered slots 350 can be all of the slots for airline 300. In this case, offered slots 350 are used in place of slots 314 with inputs 303 to generate updated mixed integer linear programming model (MILP) model 311.

This process can be performed iteratively until acceptable output schedule is obtained in which schedule matches slots. With reference again to block 344, when the schedule matches the slots, final schedule 352 is generated for use by airline 300 to operate fleet 306.

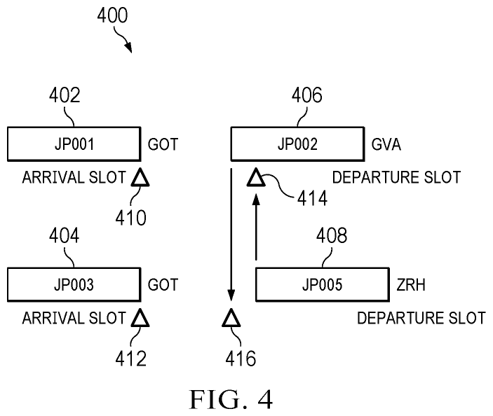

With reference next to FIG. 4, an illustration of potential flight allocations changes to slots is depicted in accordance with an illustrative embodiment. In this illustrative example, slots 400 includes arrival slot JP001 402, arrival slot JP003 404, departure slot JP002 406, and departure slot JP005 408.

Slot is often strictly linked to a flight. However, in the illustrative example, slot coordinators often do not care if a flight departs from or arrives at a particular airport as long as the flight is operated with aircraft of a similar type of a similar size. This situation opens up an ability to treat slots at airport as a portfolio of assets that can be swapped within the airline.

In this example, arrival slot JP001 402 matches flight arrival time 410 of a flight to Göteborg Landvetter Airport (GOT), and arrival slot JP003 404 matches flight arrival time 412 of a flight to Göteborg Landvetter Airport (GOT). As depicted, a mismatch is present with the departure slots. Departure slot JP002 406 has a mismatch with departure time 414 for a flight to Geneva airport (GVA), and departure slot JP005 408 has a mismatch with departure time 416 for a flight to Zürich airport (ZRH).

In this example, departure slot JP002 406 and departure slot JP005 408 can be swapped with each other to match departure time 414 and departure time 416. This swap of slots results in departure slot JP002 406 having departure time 416 for the flight to Zurich airport (ZRH), and departure slot JP005 408 having departure time 414 for the flight to Geneva airport (GVA).

As result, slot swapping provides new opportunities for aligning a flight schedule with available slots not used with current techniques. When available slots are insufficient to create a feasible schedule, a value is present for getting closer to an available slot. The value of slot alignment varies depending on airport. For example, a slot coordinator may be more likely to approve a slot change as the difference between the current slot in a desired slot becomes smaller.

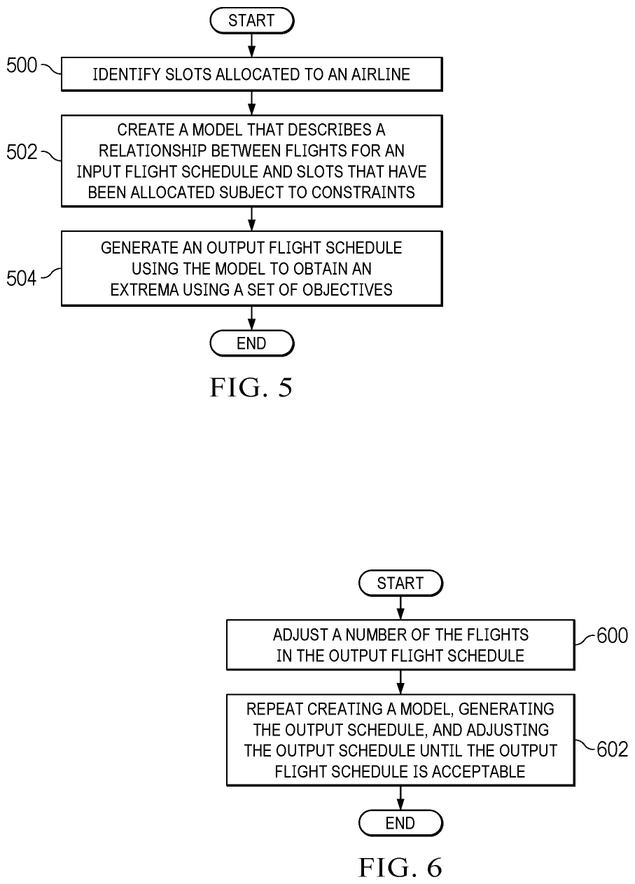

Turning next to FIG. 5, an illustration of a flowchart of a process for managing slots is depicted in accordance with an illustrative embodiment. The process in FIG. 5 can be implemented in hardware, software, or both. When implemented in software, the process can take the form of program instructions that are run by one of more processor units located in one or more hardware devices in one or more computer systems. For example, the process can be implemented in schedule generator 214 in computer system 212 in FIG. 2.

The process begins by identifying slots allocated to an airline (operation 500). The process creates a model that describes a relationship between flights for an input flight schedule and slots that have been allocated subject to constraints (operation 502).

The process generates an output flight schedule using the model to obtain an extrema using a set of objectives (operation 504). The process terminates thereafter. In operation 504, the flights are aligned to the slots in the output flight schedule. The alignment may not be exact in which every slot matches every departure or arrival time.

Turning now to FIG. 6, an illustration of a flowchart of a process for iteratively generating and output schedule is depicted in accordance with an illustrative embodiment. The process illustrated in this figure is an example of additional operations that can be performed with the operations in FIG. 5 to iteratively generate output schedules.

The process adjusts a number of the flights in the output flight schedule (operation 600). In operation 600, the output flight schedule with adjustments to the number of flights becomes the input flight schedule for to perform another iteration in response to the output flight schedule being unacceptable for use.

The process repeats creating a model, generating the output schedule, and adjusting the output schedule until the output flight schedule is acceptable (operation 602). The process terminates thereafter in operation 602. These steps correspond to operation 502, operation 504, and operation 600.

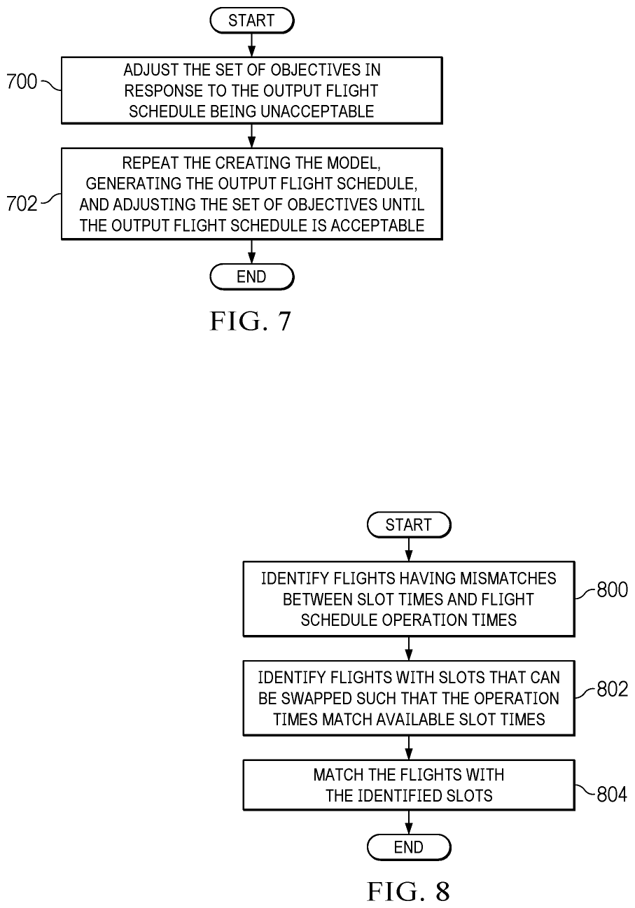

Turning next to FIG. 7, an illustration of a flowchart of a process for iteratively generating and output schedule is depicted in accordance with an illustrative embodiment. The process illustrated in this figure is an example of additional operations that can be performed with the operations in FIG. 5 to iteratively generate output schedules.

The process adjusts the set of objectives in response to the output flight schedule being unacceptable for use (operation 700). The process repeats creating the model, generating the output schedule, and adjusting the set of objectives until the output flight schedule is acceptable (operation 702). The process terminates thereafter in operation 702. These steps correspond to operation 502, operation 504, and operation 700.

In FIG. 8, an illustration a flowchart of process for swapping slots is depicted in accordance with an illustrative embodiment. The process illustrated in FIG. 8 can be implemented by model to swap slots as part of generating and output light schedule.

The process identifies flights having mismatches between slot times and flight schedule operation times (operation 800). In this example, flight schedule operation times can be arrival times or departure times for flights. The process identifies flights with slots that can be swapped such that the operation times match available slot times (operation 802). In operation 802, a flight assigned to one slot can be re-allocated to another slot. For example, slots can be departure slots that are switched with other departure slots to obtain better alignment between flights and slots. The process matches the flights with the identified slots (operation 804). The process terminates thereafter.

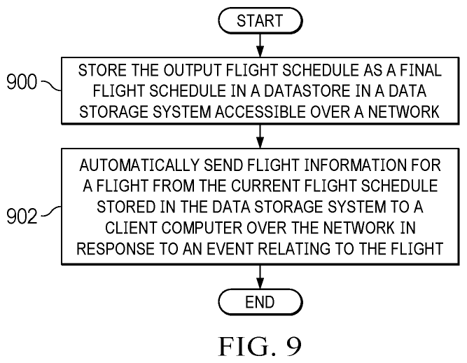

With reference next to FIG. 9, an illustration of a flowchart of a process for sending output schedules is depicted in accordance with an illustrative embodiment. The process illustrated in FIG. 9 is an example of additional operations that can be performed with the operations in FIG. 6.

The process stores the output flight schedule as a final flight schedule in a datastore in a data storage system accessible over a network (operation 900). The process automatically sends flight information for a flight from the final flight schedule stored in the data storage system to a client computer over the network in response to an event relating to the flight (operation 902). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program instructions, hardware, or a combination of the program instructions and hardware. When implemented in hardware, the hardware can, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

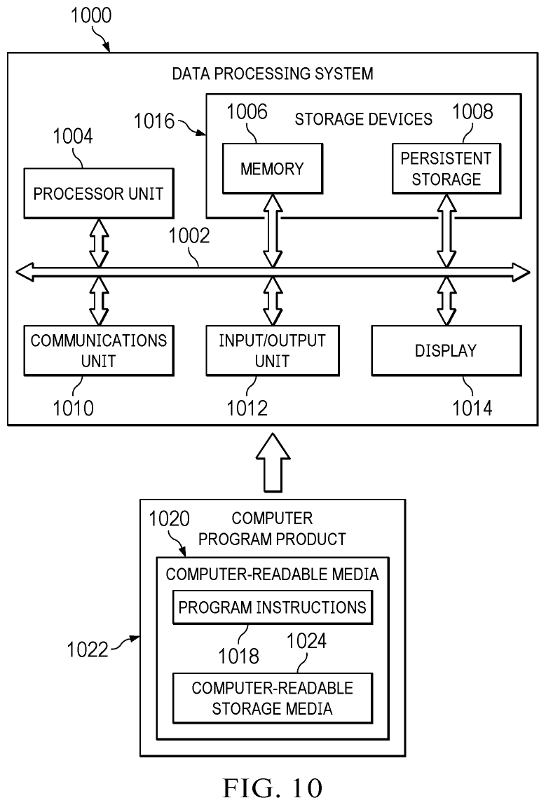

Turning now to FIG. 10, a block diagram of a data processing system is depicted in accordance with an illustrative embodiment. Data processing system 1000 can be used to implement server computer 104, server computer 106, client devices 110, in FIG. 1. Data processing system 1000 can also be used to implement computer system 212 in FIG. 2. In this illustrative example, data processing system 1000 includes communications framework 1002, which provides communications between processor unit 1004, memory 1006, persistent storage 1008, communications unit 1010, input/output (I/O) unit 1012, and display 1014. In this example, communications framework 1002 takes the form of a bus system.

Processor unit 1004 serves to execute instructions for software that can be loaded into memory 1006. Processor unit 1004 includes one or more processors. For example, processor unit 1004 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1004 can may be implemented using one or more heterogeneous processor systems in which a main processor is present with secondary processors on a single chip. As another illustrative example, processor unit 1004 can be a symmetric multi-processor system containing multiple processors of the same type on a single chip.

Memory 1006 and persistent storage 1008 are examples of storage devices 1016. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1016 may also be referred to as computer-readable storage devices in these illustrative examples. Memory 1006, in these examples, can be, for example, a random-access memory or any other suitable volatile or non-volatile storage device. Persistent storage 1008 may take various forms, depending on the particular implementation.

For example, persistent storage 1008 may contain one or more components or devices. For example, persistent storage 1008 can be a hard drive, a solid-state drive (SSD), a flash memory, a rewritable optical disk, a rewritable magnetic tape, or some combination of the above. The media used by persistent storage 1008 also can be removable. For example, a removable hard drive can be used for persistent storage 1008.

Communications unit 1010, in these illustrative examples, provides for communications with other data processing systems or devices. In these illustrative examples, communications unit 1010 is a network interface card.

Input/output unit 1012 allows for input and output of data with other devices that can be connected to data processing system 1000. For example, input/output unit 1012 may provide a connection for user input through at least one of a keyboard, a mouse, or some other suitable input device. Further, input/output unit 1012 may send output to a printer. Display 1014 provides a mechanism to display information to a user.

Instructions for at least one of the operating system, applications, or programs can be located in storage devices 1016, which are in communication with processor unit 1004 through communications framework 1002. The processes of the different embodiments can be performed by processor unit 1004 using computer-implemented instructions, which may be located in a memory, such as memory 1006.

These instructions are referred to as program instructions, computer usable program instructions, or computer-readable program instructions that can be read and executed by a processor in processor unit 1004. The program instructions in the different embodiments can be embodied on different physical or computer-readable storage media, such as memory 1006 or persistent storage 1008.

Program instructions 1018 is located in a functional form on computer-readable media 1020 that is selectively removable and can be loaded onto or transferred to data processing system 1000 for execution by processor unit 1004. Program instructions 1018 and computer-readable media 1020 form computer program product 1022 in these illustrative examples. In the illustrative example, computer-readable media 1020 is computer-readable storage media 1024.

Computer-readable storage media 1024 is a physical or tangible storage device used to store program instructions 1018 rather than a medium that propagates or transmits program instructions 1018. Computer readable storage media 1024 may be at least one of an electronic storage medium, a magnetic storage medium, an optical storage medium, an electromagnetic storage medium, a semiconductor storage medium, a mechanical storage medium, or other physical storage medium. Some known types of storage devices that include these mediums include: a diskette, a hard disk, a random access memory (RAM), a read-only memory (ROM), an erasable programmable read-only memory (EPROM or Flash memory), a static random access memory (SRAM), a compact disc read-only memory (CD-ROM), a digital versatile disk (DVD), a memory stick, a floppy disk, a mechanically encoded device, such as punch cards or pits/lands formed in a major surface of a disc, or any suitable combination thereof.

Computer readable storage media 1024 medium, as that term is used in the present disclosure, is not to be construed as storage in the form of transitory signals per se, such as at least one of radio waves or other freely propagating electromagnetic waves, electromagnetic waves propagating through a waveguide, light pulses passing through a fiber optic cable, electrical signals communicated through a wire, or other transmission media.

Further, data can be moved at some occasional points in time during normal operations of a storage device. These normal operations include access, de-fragmentation or garbage collection. However, these operations do not render the storage device as transitory because the data is not transitory while the data is stored in the storage device.

Alternatively, program instructions 1018 can be transferred to data processing system 1000 using a computer-readable signal media. The computer-readable signal media are signals and can be, for example, a propagated data signal containing program instructions 1018. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1020” can be singular or plural. For example, program instructions 1018 can be located in computer-readable media 1020 in the form of a single storage device or system. In another example, program instructions 1018 can be located in computer-readable media 1020 that is distributed in multiple data processing systems. In other words, some instructions in program instructions 1018 can be located in one data processing system while other instructions in program instructions 1018 can be located in one data processing system. For example, a portion of program instructions 1018 can be located in computer-readable media 1020 in a server computer while another portion of program instructions 1018 can be located in computer-readable media 1020 located in a set of client computers.

The different components illustrated for data processing system 1000 are not meant to provide architectural limitations to the manner in which different embodiments can be implemented. In some illustrative examples, one or more of the components may be incorporated in or otherwise form a portion of, another component. For example, memory 1006, or portions thereof, may be incorporated in processor unit 1004 in some illustrative examples. The different illustrative embodiments can be implemented in a data processing system including components in addition to or in place of those illustrated for data processing system 1000. Other components shown in FIG. 10 can be varied from the illustrative examples shown. The different embodiments can be implemented using any hardware device or system capable of running program instructions 1018.

Thus, the illustrative examples provide a method, apparatus, system, and computer program product for managing slots. A method, apparatus, system, and computer program product for managing slots. Slots allocated to an airline identified by computer system. A model that describes a relationship of flights in an input flight schedule and slots that have been allocated subject to constraints is created by the computer system. An output flight schedule is created by the computer system using the model to obtain an extrema using a set of objectives, wherein the flights are aligned to the slots in the output flight schedule.

As a result, one or more illustrative examples can generate improved flight schedules based on matching flights to slots. In the illustrative examples, slots are not tightly linked to flights. As a result, the flights can be interchanged or swapped as needed between different slots to obtain matches between flights and slots and to reduce the amount of mismatch between flights and slots when exact matches are not possible. The matching of slots is subject to constraints such as using slots for flights in the same airport. Further, constraints in swapping slots can also be based on slots being swapped for same type of aircraft or aircraft of a similar weight and performance.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for managing slots, the method comprising:
identifying, by a computer system, the slots allocated to an airline;
creating, by the computer system, a model that describes a relationship between flights for an input flight schedule and the slots that have been allocated subject to constraints; and
generating, by the computer system, an output flight schedule using the model to obtain an extrema using a set of objectives, wherein the flights are aligned to the slots in the output flight schedule.

2. The method of claim 1 further comprising:
adjusting, by the computer system, a number of the flights in the output flight schedule, wherein the output flight schedule with adjustments to the number of the flights becomes the input flight schedule to perform another iteration in response to the output flight schedule being unacceptable; and
repeating, by the computer system, the creating the model, generating the output flight schedule, and adjusting the output flight schedule the number of the flights until the output flight schedule is acceptable.

3. The method of claim 1 further comprising:
adjusting, by the computer system, the set of objectives in response to the output flight schedule being unacceptable; and
repeating, by the computer system, the creating the model, generating the output flight schedule, and adjusting the set of objectives until the output flight schedule is acceptable.

4. The method of claim 1 further comprising:
identifying, by the computer system, a set of slot changes in response to the output flight schedule being acceptable;
sending, by the computer system, a request to change the set of the slots to a slot coordinator; and
repeating, by the computer system, the creating and generating steps using the slots allocated the airline as a result of a change to the slots made in response to the request to change the set of the slots sent to the slot coordinator.

5. The method of claim 1, wherein the model swaps the slots between the flights such that increased alignment of the slots with the flights occurs.

6. The method of claim 1 further comprising:
storing, by the computer system, the output flight schedule as a final flight schedule in a datastore in a data storage system accessible over a network; and
automatically sending, by the computer system, flight information for a flight from the final flight schedule stored in the data storage system to a client computer over the network in response an event relating to the flight.

7. The method of claim 1, wherein the constraints are selected from at least one of an aircraft fleet, a buffer time between the flights, use of available aircraft, or available slots.

8. The method of claim 1, wherein the model comprises an objective function and the constraints.

9. The method of claim 1, wherein the model is a mixed integer linear programming model.

10. The method of claim 1, wherein the output flight schedule is generated using a branch and bound optimization process.

11. A flight scheduling system comprising:
a computer system;
a schedule generator in the computer system, wherein the schedule generator is configured to:
identify slots allocated to an airline;
create a model that describes a relationship between flights for an input flight schedule and the slots that have been allocated subject to constraints; and
generate an output flight schedule using the model to obtain an extrema using a set of objectives, wherein the flights are aligned to the slots in the output flight schedule.

12. The flight scheduling system of claim 11, wherein the schedule generator is configured to:
adjust a number of the flights in the output flight schedule, wherein the output flight schedule with adjustments to the number of the flights becomes the input flight schedule to perform another iteration in response to the output flight schedule being unacceptable; and
repeat creating the model, generating the output flight schedule, and adjusting the set of objectives until the output flight schedule is acceptable.

13. The flight scheduling system of claim 11, wherein the schedule generator is configured to:
adjust the set of objectives in response to the output flight schedule being unacceptable; and
repeat creating the model, generating the output flight schedule, and adjusting the set of objectives until the output flight schedule is acceptable.

14. The flight scheduling system of claim 11, wherein the schedule generator is configured to:
identify a set of slot changes in response to the output flight schedule being acceptable;
send a request to change the set of the slots to a slot coordinator; and
repeat creating the model and generating the output flight schedule using the slots allocated the airline as a result of a change to the slots made in response to the request to change the set of the slots sent to the slot coordinator.

15. The flight scheduling system of claim 11, wherein the model swaps the slots between the flights such that increased alignment of the slots with the flights occurs.

16. The flight scheduling system of claim 11, wherein the schedule generator is configured to:
store the output flight schedule as a final flight schedule in a datastore in a data storage system accessible over a network; and
automatically send flight information for a flight from the final flight schedule stored in the data storage system to a client computer over the network in response an event relating to the flight.

17. The flight scheduling system of claim 11, wherein the constraints are selected from at least one of an aircraft fleet, a buffer time between the flights, use of available aircraft, or available slots.

18. The flight scheduling system of claim 11, wherein the model comprises an objective function and constraints.

19. The flight scheduling system of claim 11, wherein the model is a mixed integer linear programming model.

20. The flight scheduling system of claim 11, wherein the output flight schedule is generated using a branch and bound optimization process.

21. A computer program product for managing slots, the computer program product comprising a computer readable storage medium having program instructions embodied therewith, the program instructions executable by a computer system to cause the computer system to:
identify the slots allocated to an airline;
create a model that describes a relationship between flights for an input flight schedule and the slots that have been allocated subject to constraints; and
generate an output flight schedule using the model to obtain an extrema using a set of objectives, wherein the flights are aligned to the slots in the output flight schedule.
